(19) United States
(12) Patent Application Publication
(10) Pub. No.: US 2026/0039173 A1
(43) Pub. Date: Feb. 5, 2026

(54) STATOR AND MOTOR INCLUDING THE SAME

(71) Applicants: HYUNDAI MOTOR COMPANY, SEOUL (KR); KIA CORPORATION, SEOUL (KR); CHUNG ANG UNIVERSITY INDUSTRY ACADEMIC COOPERATION FOUNDATION, SEOUL (KR)

(72) Inventors: Won Seok Lee, Hwaseong-si (KR); Baek Yu Kim, Hwaseong-si (KR); Chul Min Ahn, Hwaseong-si (KR); Su Hyeon Maeng, Hwaseong-si (KR); Dong Hui Cheon, Hwaseong-si (KR); Sun Sung Kwon, Hwaseong-si (KR); Yun Kyung Ji, Hwaseong-si (KR); Eui Been Jung, Ansan-si (KR); Ju Ho Park, Gumi-si (KR); Se Hyeon Cho, Cheonan-si (KR); Seon U Bae, Seoul (KR); Hyoung Soon Lee, Seoul (KR)

(73) Assignees: HYUNDAI MOTOR COMPANY, SEOUL (KR); KIA CORPORATION, SEOUL (KR); CHUNG ANG UNIVERSITY INDUSTRY ACADEMIC COOPERATION FOUNDATION, SEOUL (KR)

(21) Appl. No.: 18/970,249

(22) Filed: Dec. 5, 2024

(30) Foreign Application Priority Data
Jul. 30, 2024 (KR) 10-2024-0100637

(51) Int. Cl. H02K 9/22; H02K 1/16

(52) U.S. Cl. CPC H02K 9/223; H02K 1/16

(57) ABSTRACT

A motor for a vehicle, such as an electric vehicle, includes a stator having a plurality of coils wound thereon, and a heat spreader positioned on a cross-section of the stator. The stator coils of the stator are configured to effectively cool an internal part of the stator without a complicated structure or manufacturing difficulties.

### CROSS REFERENCE TO RELATED APPLICATIONS

This application claims under 35 U.S.C. § 119 (a) the benefit of priority to Korean Patent Application No. 10-2024-0100637 filed on Jul. 30, 2024, the entire contents of which are incorporated herein by reference.

### BACKGROUND

### Technical Field

The present disclosure relates to a motor. More particularly, it relates to cooling of a motor.

### Background Art

A motor generates rotational force by receiving electrical energy. Recently, research and development on motors that drive vehicles instead of engines are actively being conducted.

As shown in FIG. 1, a motor 800 includes a stator 810 and a rotor 830. The rotor 830 may rotate about an axis C with respect to the stator 810 by electromagnetic interaction between the stator 810 and the rotor 830. For example, coils 820 are wound on the stator 810, and coils may be wound or permanent magnets may be mounted on the rotor 830. When current is applied to the coils 820 of the stator 810 and thus the coils 820 are magnetized, the rotor 830 may rotate through interaction of the coils 820 of the stator 810 and the coils or the permanent magnets of the rotor 830.

Since a large amount of heat is generated by the current applied to the coils 820 of the stator 810 during operation of the motor 800, a cooling structure is provided in the motor 800 to ensure stable operation of the motor 800.

In general, a hot spot is located at a central part R1 of the stator 810 of the motor 800. Since the cooling performance of the central part R1 has a great influence on the performance of the motor 800, technology development for methods of efficiently cooling the deep part or the internal part of the coils 820 is actively being conducted.

The above information disclosed in this Background section is only for enhancement of understanding of the background of the disclosure and therefore it may contain information that does not form the prior art that is already known to one having ordinary skill in the art.

### SUMMARY

The present disclosure has been made in an effort to solve the above-described problems associated with the prior art, and it is an object of the present disclosure to provide a stator including a structure configured to effectively cool an internal part of a stator and a motor including the stator.

It is another object of the present disclosure to provide a stator including a structure configured to effectively cool an internal part of a stator without a complicated structure or manufacturing difficulties and a motor including the stator.

The objects of the present disclosure are not limited to the above-mentioned objects, and other objects not mentioned herein will be clearly understood by one having ordinary skill in the art to which the present disclosure pertains from the following description.

In order to achieve the above-described objects of the present disclosure and perform characteristic functions of the present disclosure, which will be described later, features of the present disclosure are as follows.

In one aspect, the present disclosure provides a motor including a stator configured such that coils are wound thereon and a heat spreader disposed on a cross-section of the stator.

Other aspects and preferred embodiments of the disclosure are discussed infra.

### BRIEF DESCRIPTION OF THE FIGURES

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 is a longitudinal cross-sectional view of an exemplary motor;

FIG. 2A is a longitudinal cross-sectional view of an exemplary motor, showing an oil cooling path through oil supplied to a rotating shaft;

FIG. 2B is a radial cross-sectional view of an exemplary motor, showing the motor cooled by a cooling medium supplied from a cooling pipe;

FIG. 3 illustrates a motor according to one embodiment of the present disclosure;

FIG. 4 illustrates a heat spreader according to one embodiment of the present disclosure;

FIG. 5A is a radial cross-sectional view of a heat spreader according to some embodiments of the present disclosure;

FIG. 5B is an enlarged view of portion S1 of FIG. 5A;

FIG. 6A is a radial cross-sectional view of a heat spreader according to some embodiments of the present disclosure;

FIG. 6B is an enlarged view of portion S2 of FIG. 6A;

FIG. 7 is a side perspective view of a motor according to some embodiments of the present disclosure;

FIGS. 8A and 8B are side perspective views of motors according to some embodiments of the present disclosure, showing a relationship between the outer diameter of a stator and the outer diameter of a heat spreader; and

FIGS. 9A and 9B are side perspective views of motors according to some embodiments of the present disclosure, showing a relationship between a heat spreader and a cooling channel.

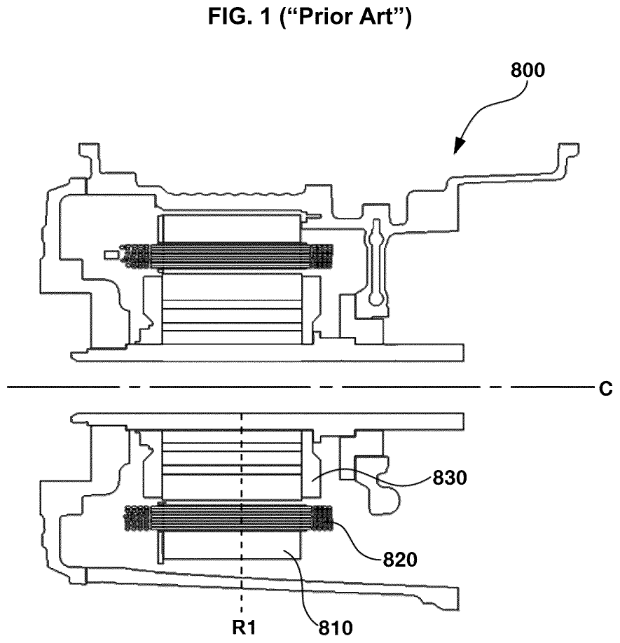

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes, will be determined in part by the particular intended application and use environment.

In the figures, reference numbers refer to the same or equivalent parts of the present disclosure throughout the several figures of the drawing.

### DETAILED DESCRIPTION

Specific structural or functional descriptions set forth in embodiments of the present disclosure will be merely exemplarily given to describe the embodiments depending on the concept of the present disclosure, and the embodiments depending on the concept of the present disclosure may be embodied in different forms. Further, it will be understood that the present disclosure should not be construed as being limited to the embodiments set forth herein, and the embodiments of the present disclosure are provided only to completely disclose the disclosure and cover modifications, equivalents or alternatives which come within the scope and technical range of the disclosure.

In the following description of the embodiments, terms, such as “first” and “second,” and the like, are used only to describe various elements, and these elements should not be construed as being limited by these terms. These terms are used only to distinguish one element from other elements. For example, a first element described hereinafter may be termed a second element, and similarly, a second element described hereinafter may be termed a first element, without departing from the scope of the disclosure.

When an element or layer is referred to as being “connected to” or “coupled to” another element or layer, it may be directly connected or coupled to the other element or layer, or intervening elements or layers may be present. In contrast, when an element or layer is referred to as being “directly connected to” or “directly coupled to” another element or layer, there may be no intervening elements or layers present. Other words used to describe relationships between elements should be interpreted in a like fashion, e.g., “between” versus “directly between,” “adjacent” versus “directly adjacent,” etc.

Wherever possible, the same reference numbers will be used throughout the drawings to refer to the same or like parts. The terminology used herein is for the purpose of describing particular embodiments only and is not intended to be limiting. As used herein, singular forms may be intended to include plural forms as well, unless the context clearly indicates otherwise. The terms “comprises,” “comprising,” “including,” and “having” are inclusive and therefore specify the presence of stated features, integers, operations, operations, elements, components, and/or combinations thereof, but do not preclude the presence or addition of one or more other features, integers, operations, operations, elements, components, and/or combinations thereof.

Hereinafter, the present disclosure will be described in detail with reference to the accompanying drawings.

Cooling of the coils 820 at an internal part of the stator 810 may be achieved, for example, by oil injection.

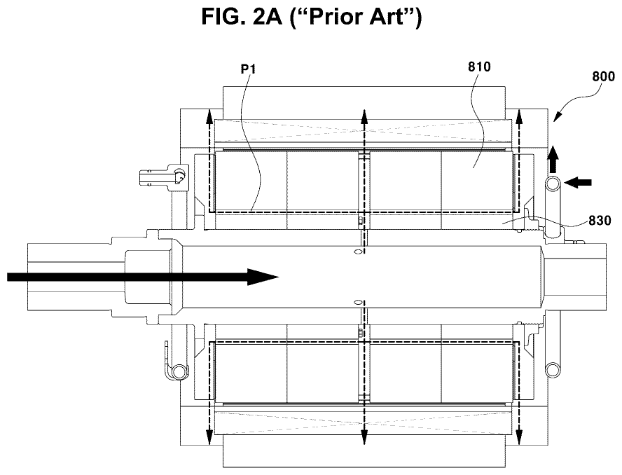

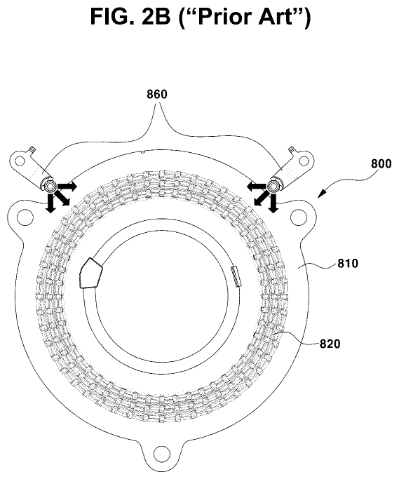

In the method illustrated in FIG. 2A, a cooling medium, such as oil, is supplied to a gap between the stator 810 and the rotor 830 through a rotating shaft of the motor 800. The supplied cooling medium may cool the motor 800 while flowing along a cooling path P1. This method has an excellent cooling effect regarding the internal part of the motor 800 but may cause reduction in efficiency due to a large oil drag.

In the method illustrated in FIG. 2B, cooling pipes 860 are disposed outside the stator 810. A cooling medium, such as oil, flows through the cooling pipes 860, and the flowing cooling medium may be sprayed toward the circumference of the stator 810. This method does not directly transfer heat from a heat source of the internal part of the stator 810 so does not exhibit an excellent cooling effect on the internal part of the stator 810.

As such, the former may provide satisfactory cooling effect on the internal part of the stator but may be associated with decreased efficiency of the motor. As for the latter, cooling effect on the internal part of the motor may be low.

Accordingly, the present disclosure aims to provide a stator not only having an excellent cooling effect regarding an internal part of the stator but also preventing efficiency reduction of a motor and a motor including the stator.

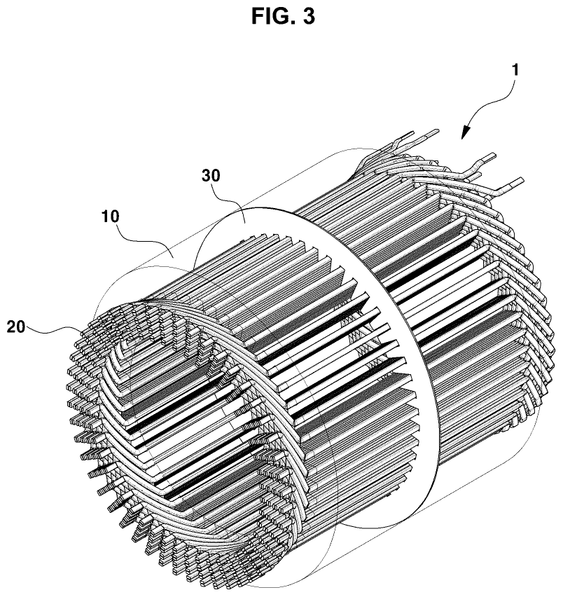

As shown in FIG. 3, a motor 1 includes a stator 10 and a rotor (not shown). The rotor may be disposed inside the stator 10 and is omitted in the drawing.

The rotor may rotate with respect to the stator 10. Coils 20 may be wound on the stator 10. The stator 10 includes stator teeth 12 and stator slots 14. The stator teeth 12 and the stator slots 14 may be alternately arranged along the circumference or the inner circumference of the stator 10. The coils 20 may be wound on the stator teeth 12. The rotor may be provided with electromagnets or permanent magnets. The rotor may rotate as a magnetic field generated by applying current to the coils 20 of the stator 10 reacts with the electromagnets or the permanent magnets of the rotor.

According to one embodiment of the present disclosure, the motor 1 includes a heat spreader 30. The heat spreader 30 may transfer heat from the internal parts of the stator 10 to the outer circumferential surface of the stator 10. For example, the heat spreader 30 may be a phase-change heat spreader. As a non-limiting example, the heat spreader 30 may be a 2-phase heat spreader 30.

The heat spreader 30 may be placed at the stator 10. In general, the stator 10 is manufactured by stacking a plurality of steel plates. The heat spreader 30 may be plate-shaped and may be stacked or inserted between the steel plates forming the stator 10. In one embodiment, the heat spreader 30 may replace a portion or the entirety of the cross-section of the stator core or the stator 10. Here, the heat spreader 30 replacing a portion of the cross-section of the stator 10 may mean that the heat spreader 30 may be placed instead of some of the steel plates stacked to form the stator 10. The heat spreader 30 replacing the entirety of the cross-section of the stator 10 may mean that the heat spreader 30 may be placed instead of all of the steel plates stacked to form the stator 10.

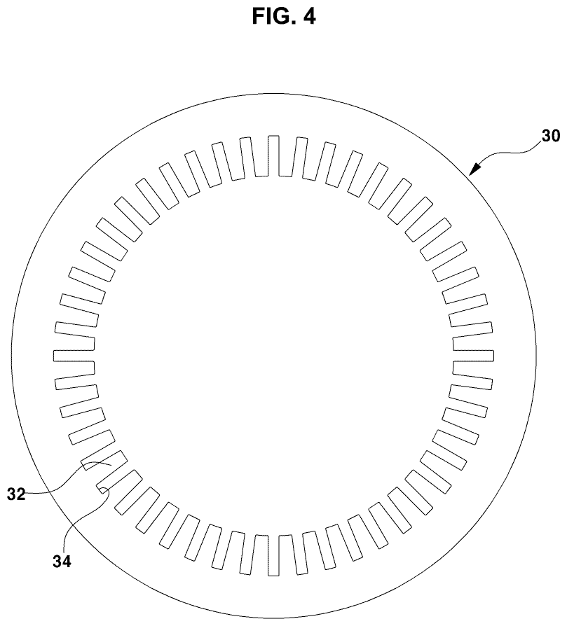

As shown in FIG. 4, the heat spreader 30 may be plate-shaped. In addition, the heat spreader 30 may generally have a ring shape. The heat spreader 30 may have substantially the same shape as the stator 10 so as to be inserted between the steel plates that form the stator 10. For example, the heat spreader 30 may include teeth 32 and slots 34. The teeth 32 and the slots 34 may be formed along the inner circumferential surface of the heat spreader 30, and the teeth 32 and the slots 34 may be formed alternately.

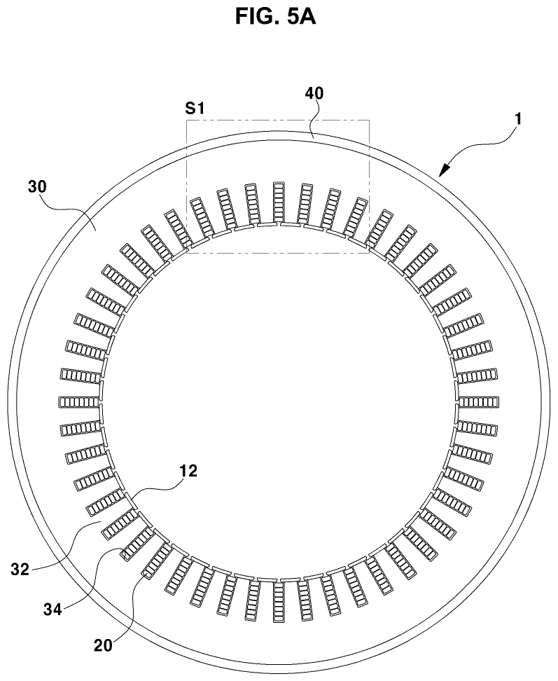

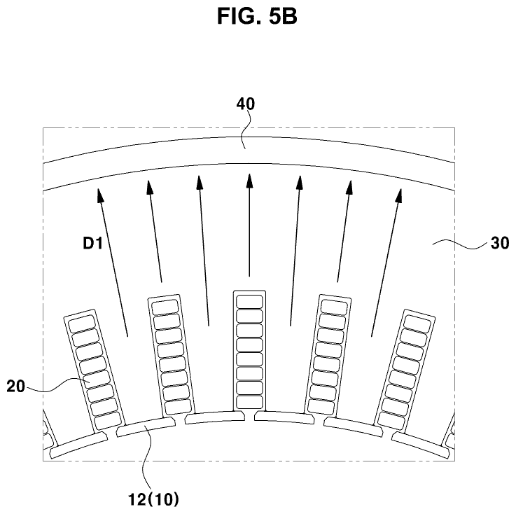

As shown in FIGS. 5A and 5B, according to one embodiment of the present disclosure, the cross-section of the heat spreader 30 may be the same as the cross-section of the stator 10. The stator teeth 12 and the stator slots 14 may overlap the teeth 32 and the slots 34 of the heat spreader 30. Heat from the internal part of the stator 10 may be transferred to the outer circumference of the heat spreader 30 in a transfer direction D1.

The motor 1 may further include a cooling channel 40. The cooling channel 40 may be formed within a housing that accommodates the stator 10. The cooling channel 40 may perform cooling in an oil-cooled, water-cooled, or air-cooled manner. In one example, the cooling channel 40 may be formed around the stator 10. Therefore, the heat transferred to the outer circumference of the heat spreader 30 in the transfer direction D1 through the heat spreader 30 may be cooled off in the cooling channel 40.

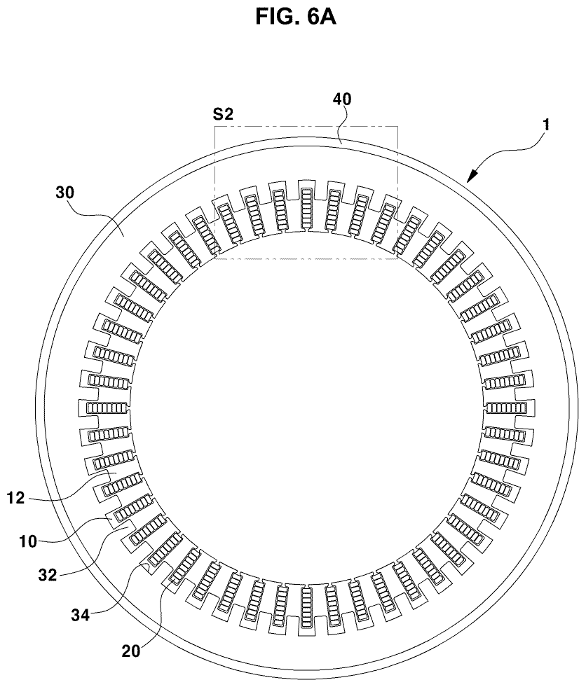

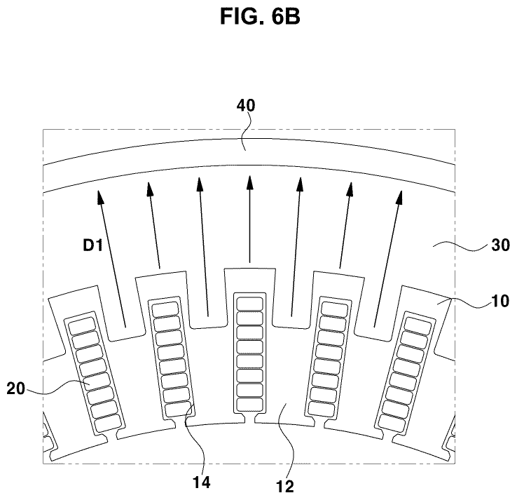

As shown in FIGS. 6A and 6B, according to another embodiment of the present disclosure, the heat spreader 30 may overlap a portion of the stator 10. The teeth 32 of the heat spreader 30 may overlap a portion of each of the stator teeth 12, and the slots 34 of the heat spreader 30 may overlap a portion of each of the stator slots 14. In this embodiment, heat from the internal part of the stator 10 is transferred to the outer circumference of the heat spreader 30 in the transfer direction D1 through the heat spreader 30, and the heat may be cooled off in the cooling channel 40.

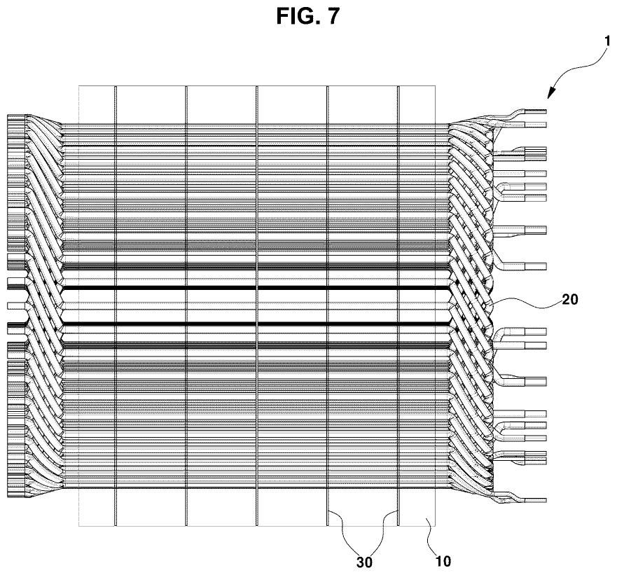

As shown in FIG. 7, according to one embodiment of the present disclosure, the motor 1 may include a plurality of heat spreaders 30. The heat spreaders 30 may be disposed between the steel plates that form the stator 10. In one example, that plurality of heat spreaders 30 may be disposed at a certain interval on the motor 1. In one example, as many heat spreaders 30 as necessary may be disposed on the motor 1. Here, the certain interval may literally mean a predetermined interval. Therefore, if the plurality of the heat spreaders 30 are disposed on the motor 1, the respective heat spreaders 30 may be disposed at the same interval, as in the illustrated embodiment. Otherwise, if the plurality of the heat spreaders 30 are disposed on the motor 1, the respective heat spreaders 30 may not be disposed at the same interval but may be disposed at different intervals, unlike the illustrated embodiment. In other words, the intervals between the heat spreaders 30 disposed on the motor 1 may be different.

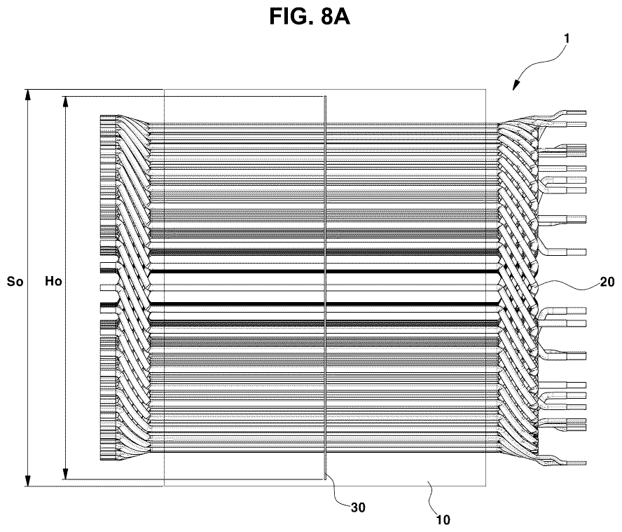

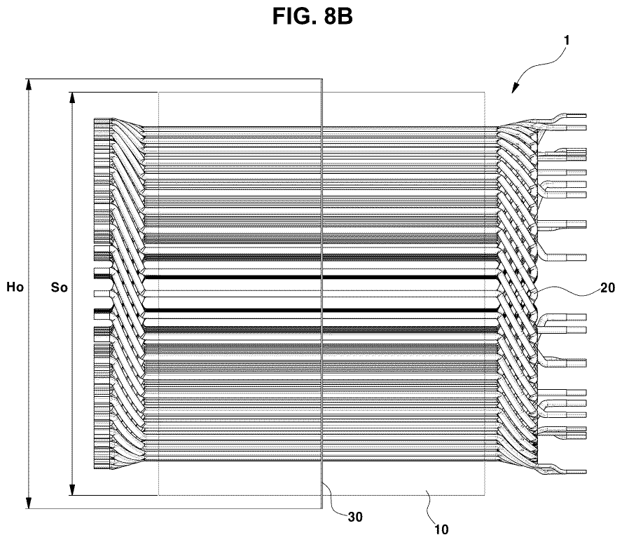

According to one embodiment of the present disclosure, the outer diameter (Ho) of the heat spreader 30 may be smaller or greater than the outer diameter (So) of the stator core or the stator 10. In some embodiments, as shown in FIG. 8A, the outer diameter (Ho) of the heat spreader 30 may be smaller than the outer diameter (So) of the stator 10. In some embodiments, as shown in FIG. 8B, the outer diameter (Ho) of the heat spreader 30 may be greater than the outer diameter (So) of the stator 10. In this case, the heat spreader 30 may extend outward in the radial direction of the stator 10.

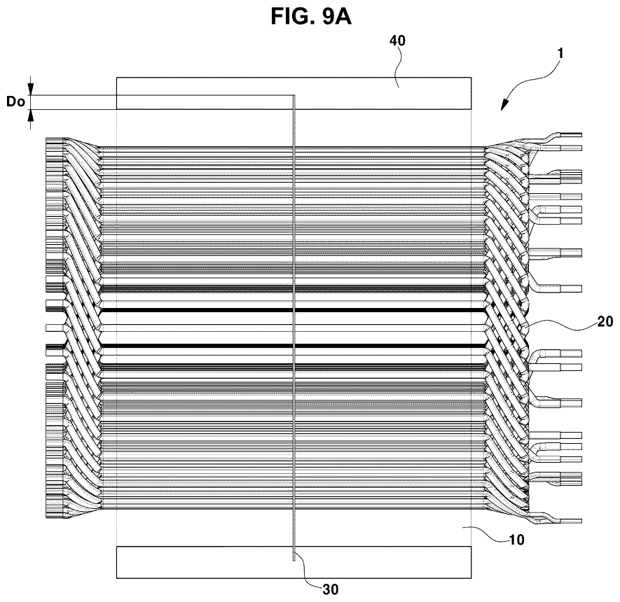

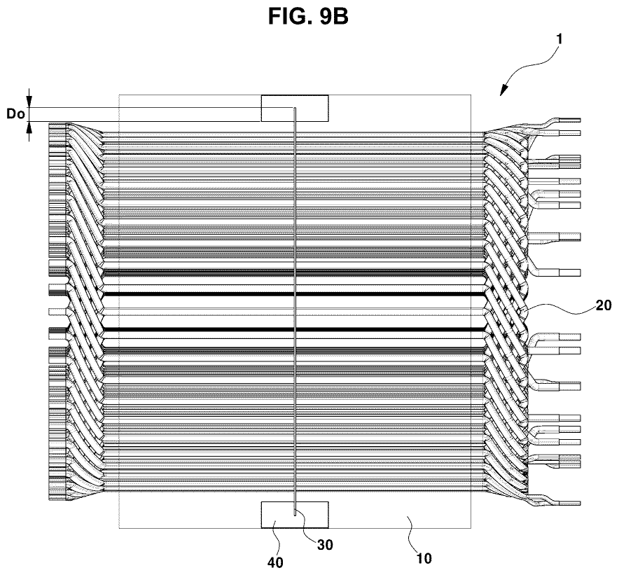

As shown in FIGS. 9A and 9B, according to one embodiment of the present disclosure, the heat spreader 30 may overlap the cooling channel 40. An overlap portion (Do) of the heat spreader 30, which overlap the cooling channel 40, may extend to the inside of the cooling channel 40.

If an epoxy molding compound (EMC) molding structure is applied to the coils 20, heat dissipation after the coils 20 and the heat spreader 30 may be defined by a heat transfer system.

In some embodiments of the present disclosure, an electric vehicle may include the motor 1.

The motor 1 according to the present disclosure may improve heat dissipation of the internal part of a stator.

As is apparent from the above description, the present disclosure provides a stator including a structure configured to effectively cool an internal part of a stator, and a motor including the stator.

Further, the present disclosure provides a stator including a structure configured to effectively cool an internal part of a stator without a complicated structure or manufacturing difficulties, and a motor including the stator.

The effects of the present disclosure are not limited to the above-mentioned effects, and other effects not mentioned herein will be clearly understood by those skilled in the art from the above description.

The disclosure has been described in detail with reference to preferred embodiments thereof. However, it will be appreciated by those skilled in the art that changes may be made in these embodiments without departing from the principles and spirit of the disclosure, the scope of which is defined in the appended claims and their equivalents.

1. A motor comprising:
a stator having a plurality of coils wound thereon; and
a heat spreader positioned on a cross-section of the stator.

2. The motor of claim 1, wherein the heat spreader is a phase-change heat spreader.

3. The motor of claim 1, wherein the stator comprises a plurality of steel plates stacked on each other, and wherein the heat spreader is positioned between at least some of the plurality of steel plates.

4. The motor of claim 1, wherein a cross-section of the heat spreader is equal to the cross-section of the stator.

5. The motor of claim 1, wherein the heat spreader overlaps at least a portion of the stator.

6. The motor of claim 1, wherein:
the stator comprises a plurality of stator teeth, and wherein the plurality of coils wound on the plurality of stator teeth; and
the heat spreader comprises a plurality of spreader teeth configured to overlap at least a portion of the plurality of stator teeth.

7. The motor of claim 6, wherein the plurality of coils are wound around the plurality of stator teeth and the plurality of spreader teeth.

8. The motor of claim 1, wherein an outer diameter of the heat spreader is smaller or greater than an outer diameter of the stator.

9. The motor of claim 1, further comprising a cooling channel formed around the stator.

10. The motor of claim 9, wherein the heat spreader extends to the cooling channel.

11. The motor of claim 1, further comprising a rotor including a plurality of permanent magnets and configured to be rotatable with respect to the stator.

12. An electric vehicle comprising the motor of claim 1.
